(19) United States
(12) Patent Application Publication
(10) Pub. No.: US 2017/0022741 A1
(43) Pub. Date: Jan. 26, 2017

(54) DOOR ASSEMBLY FOR VEHICLES

(71) Applicant: Monroe Truck Equipment, Inc., Monroe, WI (US)

(72) Inventors: Andrew Holverson, Monroe, WI (US); Mark D. Byerley, Monroe, WI (US)

(21) Appl. No.: 14/807,256

(22) Filed: Jul. 23, 2015

(51) Int. Cl. E05D 15/16; B60J 5/04; E05D 15/44; E06B 3/50; E05D 13/00; E05D 15/24

(52) U.S. Cl. CPC E05D 15/165; E05D 13/003; E05D 15/248; E05D 15/44; E06B 3/5018; B60J 5/0491; B60J 5/047; E05Y 2900/50

(57) ABSTRACT

Embodiments of the invention provide a opening and closing assembly for a rigid door panel that is rotatably attached to a roller received within a track on a door frame member. A support member can be rotatably attached to the door panel. A first pivot arm can extend inboard from the support member to pivotally attach to an inboard frame member. Upon application of an upward force to the door panel, the first pivot arm can pivot with respect to the first inner frame member to move the support member in an arcuate path. The support member can thereby move the door panel upward and inboard along a door path at least partly defined by the track, with a lower end of the door panel not extending substantially outboard of the door frame member as the door panel moves along the door path.

### BACKGROUND

Vehicles of different types can include internal compartments that are at least partly enclosed by doors. In some applications, it can be useful to reduce the degree to which such doors extend beyond certain boundaries of the vehicles, when the doors are opened and closed. For example, if a door to a side compartment of a vehicle opens substantially outboard of the side of the vehicle, the door may be at risk of impacting other objects (e.g., other vehicles) if the door is inadvertently left open during vehicle travel. Similarly, in work areas with low clearances between a relevant vehicle and various external objects (e.g., walls, parked vehicles, and so on), it may be impossible or impractical to operate a door that extends substantially outboard of a vehicle when opened or closed.

In conventional designs, low-clearance door assemblies can include multiple panels that are hingedly connected in series to form a segmented, non-rigid door. Due to the hinges between the various panels, this type of door can sometimes be opened and closed without extending outboard of local vehicle features (e.g., bulkhead walls or vehicle side panels). However, the manufacturing of these doors can be relatively expensive, and the large number of moving parts can increase maintenance costs. Accordingly, a need exists for an improved door assembly, and a related opening and closing assembly, that keep a door from extending substantially outboard of a vehicle during operation.

### SUMMARY

Some embodiments of the disclosure provide an opening and closing assembly for a vehicle with a first inboard frame member and a door assembly. The door assembly can include a rigid door panel configured to at least partly cover a door opening, a roller rotatably attached to the rigid door panel, and a door frame member supporting a track. The track can be configured to receive the roller and can extend from a bottom end of the track at least partly upward and inboard, with respect to the vehicle.

The opening and closing assembly can include a support member rotatably attached to the rigid door panel and extending horizontally along the rigid door panel. A first pivot arm can be rigidly connected to or integrally formed with the support member, and can extend inboard from the support member, with respect to the utility vehicle, to pivotally attach to the first inboard frame member. Upon an application of an upward force to the rigid door panel, with the rigid door panel in a closed orientation, the first pivot arm can pivot with respect to the first inner frame member to move the support member in an arcuate path extending upward and inboard, with respect to the vehicle. The support member can thereby move the rigid door panel upward and inboard, towards a fully open orientation, along a door path at least partly defined by the track, such that a lower end of the rigid door panel does not extend substantially outboard of the door frame member as the rigid door panel moves between the closed and fully open orientations.

Other embodiments of the disclosure provide a door assembly for a vehicle with a door opening and a first inboard frame member. A rigid door panel can be configured to at least partly cover the door opening. A roller can rotatably attached to the rigid door panel. A track can be supported by a door frame member, with the track configured to receive the roller and extending from a bottom end of the track at least partly upward, with respect to the vehicle.

A support member can be rotatably attached to the rigid door panel. A first pivot arm can be rigidly connected to or integrally formed with the support member, and can extend inboard from the support member, with respect to the utility vehicle, to pivotally attach to the first inboard frame member. Upon an application of an upward force to the rigid door panel, with the rigid door panel in a closed orientation, the first pivot arm can pivot with respect to the first inner frame member to move the support member in an arcuate path upward and inboard, with respect to the vehicle. The support member can thereby move the rigid door panel upward and inboard, towards a fully open orientation of the rigid door panel, along a door path at least partly defined by the track, such that a lower end of the rigid door panel does not extend substantially outboard of the door frame member as the rigid door panel moves between the closed and fully open orientations.

Still other embodiments of the disclosure provide a door assembly for a vehicle with a utility compartment including an inboard storage area, a door opening, first and second bulkhead walls disposed on respective sides of the door opening, and first and second inboard supports. The door assembly can include a rigid door panel configured to at least partly cover the door opening. First and second tracks can be supported by the first and second bulkhead walls, respectively, and can extend upward, with respect to the vehicle, from respective first and second bottom ends of the first and second tracks. First and second rollers can be rotatably attached to respective sides of the rigid door panel at a bottom end of the rigid door panel, with the first and second rollers configured, respectively, to move along the first and second tracks.

A support member can be pivotally attached to, and extend horizontally along, the rigid door panel. First and second pivot arms can extend inboard, with respect to the vehicle, from first and second ends, respectively, of the support member, in order to pivotally attach the first and second inboard supports, respectively. Upon an application of an upward force to the rigid door panel, with the rigid door panel in a closed orientation, the first and second pivot arms can pivot with respect to the first and second inboard supports, respectively, to move the support member in an arcuate path upward and inboard, with respect to the vehicle. The horizontal door support can thereby move the rigid door panel upward and inboard, towards a fully open orientation of the rigid door panel, along a door path at least partly defined by the first and second tracks.

### BRIEF DESCRIPTION OF THE DRAWINGS

The accompanying drawings, which are incorporated in and form a part of this specification, illustrate embodiments of the invention and, together with the description, serve to explain the principles of embodiments of the disclosure:

FIG. 1A is a perspective view of a compartment body for a vehicle, with a door assembly according to one embodiment of the disclosure, and with a door panel of the door assembly in a closed orientation;

FIG. 1B is a cross-sectional view of the compartment body of FIG. 1A, taken along the plane A-A and showing the door panel in the closed configuration;

FIG. 1C is a perspective view of a track and a roller for the door assembly of FIG. 1A, illustrating movement of the roller along the track;

FIG. 2 is a perspective view of pivot arrangements, including biasing assemblies, for the door assembly of FIG. 1A;

FIG. 3A is a perspective view of the compartment body and door assembly of FIG. 1A, with the door panel in a partially open orientation;

FIG. 3B is a cross-sectional view of the compartment body and door assembly as illustrated in FIG. 3A, taken along the plane B-B of FIG. 3A;

FIG. 4A is a perspective view of the compartment body and door assembly of FIG. 1A, with the door panel in a fully open orientation;

FIG. 4B is a cross-sectional view of the compartment body and door assembly as illustrated in FIG. 4A, taken along the plane C-C of FIG. 4A;

FIG. 4C is an elevational view of area D-D of FIG. 4B, showing a track assembly and a roller of the door assembly as illustrated in FIG. 4A;

FIG. 5 is a top elevational view of aspects of a door assembly according to another embodiment of the disclosure;

FIG. 6 is a top elevational view of aspects of a door assembly according to still another embodiment of the disclosure;

FIG. 7 is a top elevational view of an example cover for the compartment body and door assembly of FIG. 1A; and

FIGS. 8A and 8B are side schematic views of another example cover for the compartment body and door assembly of FIG. 1A, in unfolded and folded configurations, respectively.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Likewise, “at least one of A, B, and C,” and the like, is meant to indicate A, or B, or C, or any combination of A, B, and/or C. Unless specified or limited otherwise, the terms “mounted,” “secured,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise specified or limited, the terms “horizontal,” “vertical,” and the like specify orientations with respect to a nominal, flat-ground orientation of a relevant vehicle. For example, a “horizontal” member of a vehicle can be a member that extends generally normal to the direction of gravity, when the vehicle is on flat ground. Accordingly, when the vehicle is not on flat ground (e.g., is traveling up a slope), such a “horizontal” member may be orientated at a non-right angle to the direction of gravity. Similarly, a “vertical” member of a vehicle can be a member that extends generally in parallel with the direction of gravity, when a vehicle is on flat ground. Accordingly, when the vehicle is not on flat ground, such a “vertical” member may be orientated at an angle to the direction of gravity

Also as used herein, unless otherwise specified or limited, the terms “inboard,” “outboard,” and the like specify directions with respect to a relevant vehicle. For example, an “inboard” movement can be a movement that is at least partly in a direction extending from an exterior area of a vehicle to an interior area of the vehicle (e.g., a direction extending from an exterior panel of the vehicle to an internal compartment of the vehicle). Likewise, an “outboard” movement can be a movement that is at least partly in a direction extending from an interior area of a vehicle to an exterior area of the vehicle (e.g., a direction extending from an internal compartment of the vehicle to an exterior panel of the vehicle).

Also as used herein, unless otherwise specified or limited, the term “u-shaped” specifies a shape that includes a base portion, with leg portions extending from the base portion in generally similar directions. In some embodiments, a “u-shaped” member can include legs extending from the base portion at substantially right angles to opposite ends of the base portion with or without curved connecting regions between the legs and the base.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As noted above, it may be useful for a door of a vehicle compartment to open and close without extending substantially outboard of the sides or rear of a vehicle. For side compartments of a vehicle, for example, using a door that does not extend substantially outboard of the side of the vehicle during opening and closing (and when fully opened and closed) can significantly reduce the likelihood of the door catching on or striking objects outside the vehicle during opening and closing. Use of such a door can also significantly reduce the likelihood of the door catching on or otherwise impacting objects outside the vehicle if the door is left open (e.g., inadvertently) during vehicle travel.

The door assembly and the related door opening and closing assembly disclosed herein can provide such a benefit, among others. As discussed in greater detail below, for example, some embodiments of the disclosed door assembly can include at least one track that extends at least partly vertically along an outboard end of a vehicle compartment. At least one roller rotatably secured to a lower end of a rigid door panel can be disposed within a respective one of the tracks, such that travel of the roller within the track can cause the door panel to move along a door path. A support member can be pivotally secured to the rigid door panel at an opposite end of the rigid door panel, with pivot arms extending from the support member to pivot points on a rigid frame member of (or attached to) the vehicle.

When an upward force is applied to the closed door panel, the pivot arms can pivot upward, guiding the support member along an arcuate path that extends upward and inboard with respect to the vehicle. As the rollers move along the track, the door panel can accordingly be opened such that the lower end of the door panel does not extend substantially outboard of the tracks (or a body supporting the tracks) during the opening operation. Likewise, when downward force is applied to the open door panel, the pivot arms can pivot downward, guiding the support member along an arcuate path that extends downward and outboard with respect to the vehicle. As the rollers move along the track, the door panel can accordingly be closed, with the lower end of the door panel not extending substantially outboard of the tracks (or a member supporting the tracks) during the closing operation.

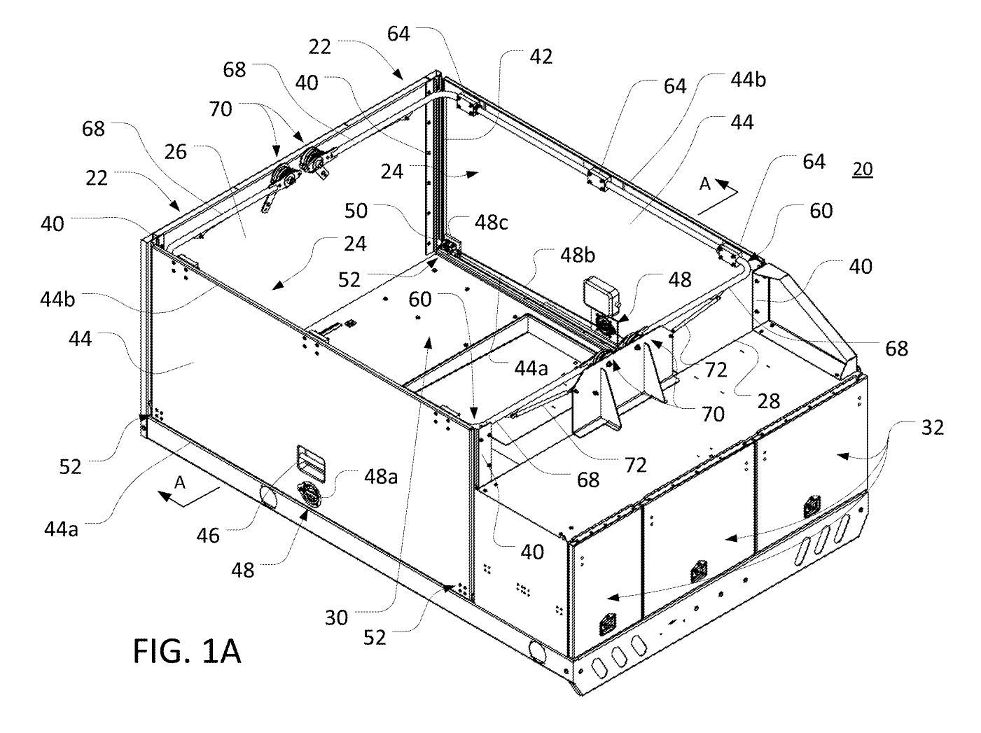

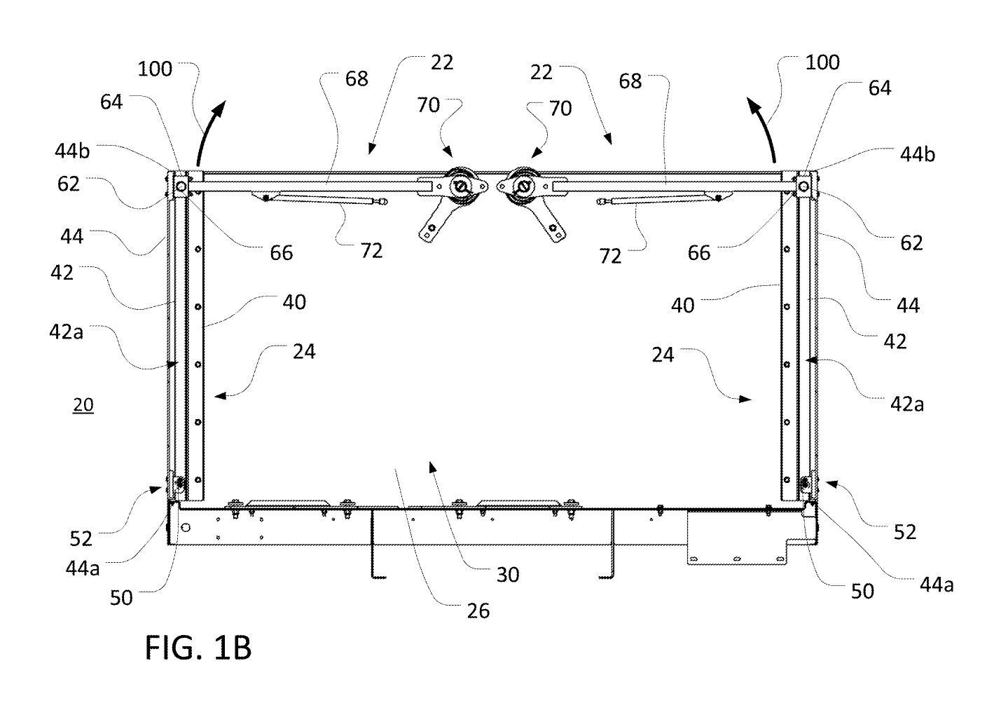

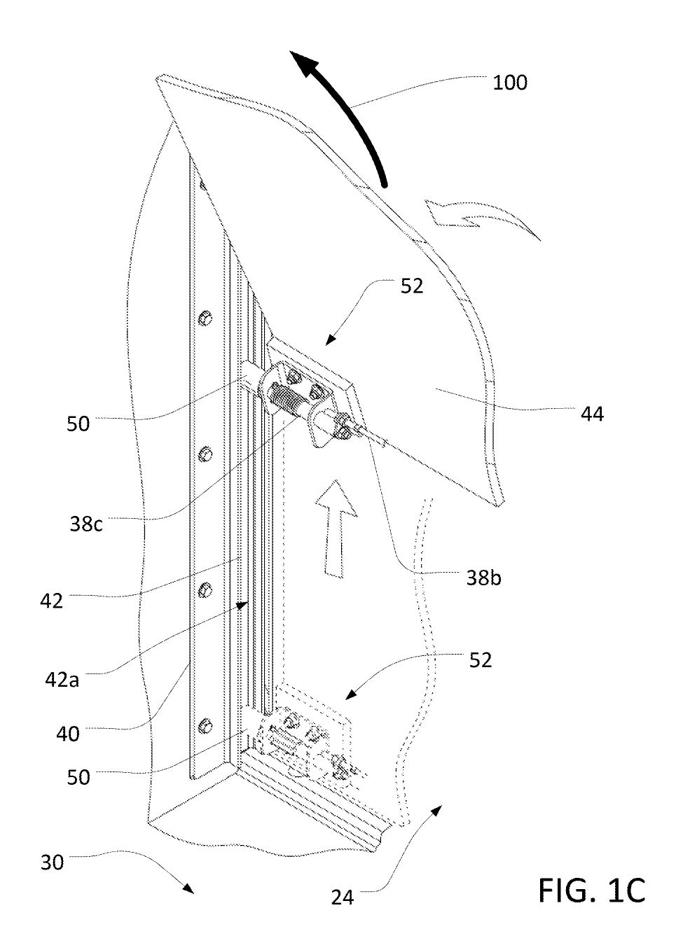

FIG. 1 illustrates a vehicle compartment body 20 with example door assemblies 22 according to one embodiment of the disclosure. In the embodiment depicted, the compartment body 20 is configured to be supported on a vehicle frame (not shown), such that door openings 24 are disposed at the sides of the vehicle. In other embodiments, other configurations are possible. Two door assemblies 22 are depicted in FIG. 1, each with a generally similar configuration to the other. As such, some discussion below may expressly address only one of the door assemblies 22. In some embodiments, other numbers of door assemblies can be used, as can multiple door assemblies having different configurations.

The compartment body 20 includes bulkhead walls 26 and 28 (and others), that generally define an internal compartment 30, including various storage areas. As depicted, the internal compartment 30 extends over the entire width of the compartment body 20, such that the door assemblies 22 can provide access to respective opposite sides of the compartment 30. The bulkhead wall 28, which can be generally disposed at the rear of the vehicle frame, can further define additional compartments 32. In other embodiments, other arrangements are possible, including arrangements with differently configured compartments.

A door frame member 40 is provided at opposite sides of the door openings 24. The door frame members 40 can be rigidly secured to the bulkhead walls 26 and 28, integrally formed with the bulkhead walls 26 and 28, or otherwise rigidly secured to the vehicle frame. A respective track 42 is included on, or otherwise supported by each of the door frame members 40, and is configured to receive an associated roller 44. As depicted, each of the tracks 42 includes a central channel 42a (see, e.g., FIG. 1B) extending generally vertically upward from a bottom end of the respective track 42. In other embodiments, the tracks 42 can be configured with a slanted channel (not shown), a curved channel (not shown), or in various other ways.

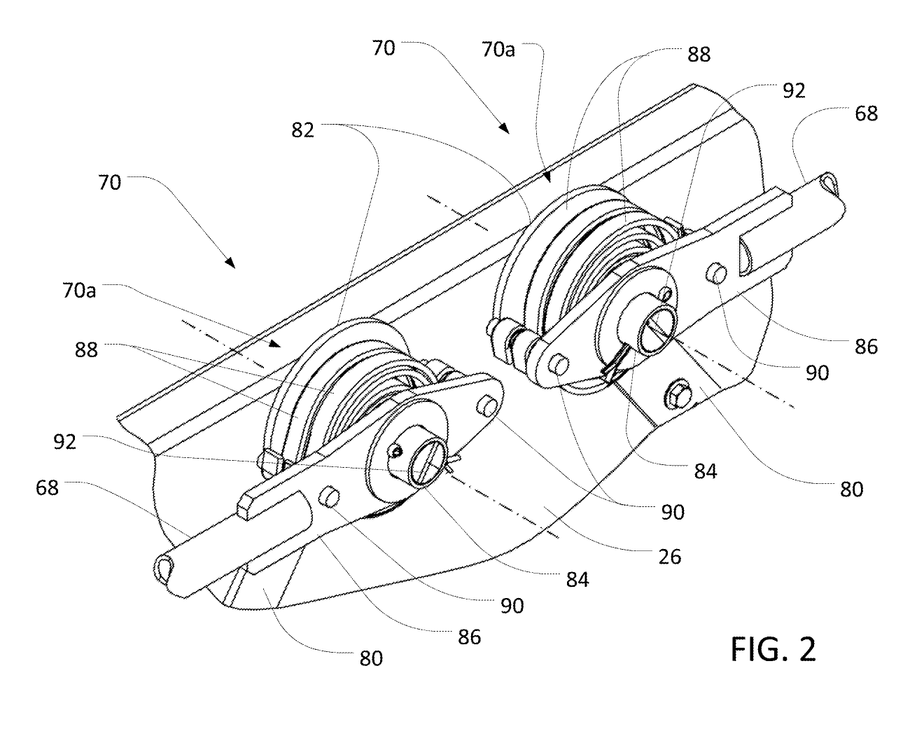

Each of the door assemblies 22 includes a rigid door panel 44, which can be formed as a single-piece metal or plastic panel, or in various other ways. A handle 46 and locking device 48 can be provided on each of the door panels 44. As depicted, each of the locking devices 48 includes a rotatable handle 48a, configured to move locking rods 48b. By rotating the handle 48a, a user can accordingly move the locking rods 48b in and out of locking holes (not shown in FIG. 1A) to lock and unlock the door assemblies 22. As depicted in FIG. 2C, the locking rods 48b can connect to spring-loaded locking pins 48c. In other embodiments, other handles or locking devices (or no handles or locking devices) can be provided.

To help move the door panels 44 between closed and fully open orientations, rollers 50 are rotatably secured at opposite sides of each door panel 44, proximate bottom ends 44a of the door panels 44. In some embodiments, this may not necessarily correspond to the rollers 50, or rotational axes thereof, being exactly aligned with the bottom ends 44a of the door panels 44. In the embodiment depicted in FIGS. 1A and 1B, for example, it can be seen that roller mounting arrangements 52 are disposed at the bottom ends 44a of the door panels 44, such that rotational axes of the rollers 50 are disposed somewhat above the bottom ends 44a of the door panels. In other embodiments, the roller mounting arrangements 52 can be configured such that the axes of the rollers 50 are substantially aligned with the bottom ends 44a of the door panels.

The rollers 50 are configured to be seated in the channels 42a of the tracks 42, such that the rollers 50 can travel along a roller path that is defined by the channels 42a (and, generally, the tracks 42). As depicted, the channels 42a are internal channels, such that the rollers 50 can be seated within the channels 42a for travel. In some embodiments, the tracks 42 can include other outwardly-extending features, with the rollers 50 (or other rollers) configured to travel along the outside of those features.

Also to help move the door panels 44 move between closed and fully open orientations, a support body 60 is rotatably mounted to the door panels 44 at mounting locations that are generally proximate upper ends 44b of the door panels 44. Each support body 60 includes a support member 62 that is pivotally secured to, and extends horizontally across, the respective door panel 44. The support member 62 can be pivotally secured to the door panels 44 in various ways. As depicted, for example, the support member 62 extends through a number of mounting blocks 64, which are rigidly secured to the door panel 44. The mounting blocks 64 can include bores 66 (see, e.g., FIG. 1B), which are dimensioned to secure the support members 62 to the door panels 64, while also allowing the support members 62 to rotate relative to the door panels 64. As depicted in FIG. 1A, the support members 62 include single-piece tubular bodies substantially extending across the entire widths of the door panels 44. In some embodiments, a support member can be formed from multiple pieces, or can be configured to extend only partly across a door panel. In some embodiments, the support member can extend only minimally along a door panel. For example, a support member in some embodiments can be configured as a pivotal attachment mechanism (e.g., a mounting bracket with a pivot pin for attachment to a pivot arm), rather than an extended body.

At either end of each support member 62, pivot arms 68 extend inboard towards pivot arrangements 70, which are also described below with regard to FIG. 2. As depicted, two of the pivot arms 68 are integrally formed with a respective one of the support members 62 in order to form the support body 60 as a single piece. In some embodiments, pivot arms similar to the pivot arms 60 can be formed separately from a support member and then joined to the support member in various ways (e.g., welded, attached with fasteners, and so on).

In some embodiments, damping devices can be employed to generally resist downward movement of the pivot arms 68 or the support members 62. This can be useful, for example, to prevent the door panels 44 from moving downward unexpectedly or too quickly, from an open orientation. Damping devices can include, for example, gas or hydraulic cylinders, orifice plates, or other devices. In the embodiment depicted in FIG. 1, various damping devices configured as gas cylinders 72 are used. The gas cylinders 72 can be configured, for example, to hold the door panels 44 in a fully open (or other) orientation, until sufficient downward force is applied by a user to close the door panels 44. In some embodiments, a damping device can also (or alternatively) help to move the pivot arms 68 or the support members 62 in a particular direction. For example, the gas cylinders 72 can be configured to accumulate and then retain internal pressure as the door panels 44 are moved downward to a closed orientation, such that the gas cylinders 72 can later provide upward force to assist a user in opening the door panels 44.

Still referring FIG. 1B, in order to open one of the door panels 44, a user can grasp the corresponding handle 26 (see FIG. 1A) and urge the door panel 44 upward. As guided by the tracks 42 (via the rollers 50), and the pivot arms 68 (via the support member 62), the door panel 44 can then move upwardly and inboard along a door path 100.

FIG. 1C illustrates the interoperation of one of the tracks 42, one of the rollers 50, and the door panel 44 as the door panel 44 is opened. The roller 50, roller mounting arrangement 52, and door panel 44 in FIG. 1C are depicted in dotted relief as the components are disposed when the door panel is oriented as in FIGS. 1A and 1B, and in solid relief as the components are disposed after the door panel 44 has been partially opened. As the door panel 44 is lifted, the roller 50 travels generally upwardly along the channel 42a of the track 42. Due to the attachment of the roller mounting arrangement 52 to the door panel 44, the track 42 accordingly determines part of the movement of the door panel 44 along the door path 100. The arcuate movement of the pivot arms 68 about the pivot arrangements 70 (not shown in FIG. 1C) can cause the top end 44b of the door panel 44 (not shown in FIG. 1C) to move inboard, such that the door panel pivots somewhat about the roller 50. However, due to the configuration of the disclosed arrangement, including the disposition of the roller mounting arrangement 52 proximate the bottom end 44a of the door panel 44, this pivoting of the door panel 44 may not cause the bottom end 44a of the door panel 44 to move substantially outboard of the track 42 or the door frame member 40 (and the compartment 30, generally). As noted above, this can be useful in a variety of applications.

FIG. 2 illustrates an example configuration for the pivot arrangements 70, which employs spring assemblies 70a to bias the pivot arms 68 upwards. In other embodiments, other arrangements can be used. In the depicted embodiment of the pivot arrangements 70, integrally formed (e.g., stamped) anchoring bodies for the pivot arms 68 include anchor arms 80 extending away from anchor discs 82. The anchoring bodies can be attached to a relevant frame member, such as the bulkhead walls 26 and 28, with the extended anchor arms 80 providing structural reinforcement of the anchoring bodies with respect to the torque required to anchor the pivot arms 68 to the frame member (and the vehicle) during operation. Rigid spindles 84 extend from the anchor discs 82, and include respective spring slots 92 to receive one or more spiral springs 88.

In some embodiments, other types of spring assemblies can be used. For example, compression or tension springs can be used, in various configurations. As another example, springs can be incorporated into damping devices such, as the gas cylinders 72, rather than as part of separate assemblies. This can be beneficial, for example, to reduce the effect of temperature variations on damping device performance. In some embodiments, rather than a physical spring, damping devices can include valve assemblies that serve a similar purpose as a physical spring.

The pivot arms 68 can be pivotally secured to the anchoring bodies in various ways, and can also be attached to the springs 84, such that the pivot arms 68 can pivot to open the door panels 24, as assisted (or resisted) by the springs 84. In the embodiment depicted, for example, an attachment plate 86 can be rigidly secured at one end to one of the pivot arms 68. The attachment plate 86 can also include a bore to receive one of the spindles 84 extending from the anchor discs 82. When movably secured to the spindles 84 (e.g., with a washer and cotter pin, as depicted in FIG. 2), the attachment plates 86 can accordingly pivot about the spindles 84 in order for the pivot arms 68 also to pivot. Further, spring pins 90 extending through (or from) the attachment plates 86 can engage the various springs 88 in order to compress (e.g., wind) the springs 88 when the pivot arms 68 are pivoted in a first direction (e.g., upward), and release (e.g., unwind) the springs 88 when the pivot arms 68 are pivoted in a second direction (e.g., downward).

As the door panels 44 are moved along the door paths 100, the pivot arrangements 70 and the gas cylinders 72 (or other pivot arrangements and damping devices) can be charged, or released, as appropriate. For example, as depicted, the springs 88 (see FIG. 2) are generally compressed (e.g., wound) when the door panels 44 are closed, so that the springs 88 can release (e.g., unwind) as the door panels 44 are opened. The springs 88 can thereby assist the upward and inboard movement of the door panels 44 to reduce the lifting force required from a user. In other embodiments, where it may be desirable to bias the door panels 44 closed, the springs 88 (or other biasing devices) can instead be compressed (or otherwise charged) by the opening of the door panels 44.

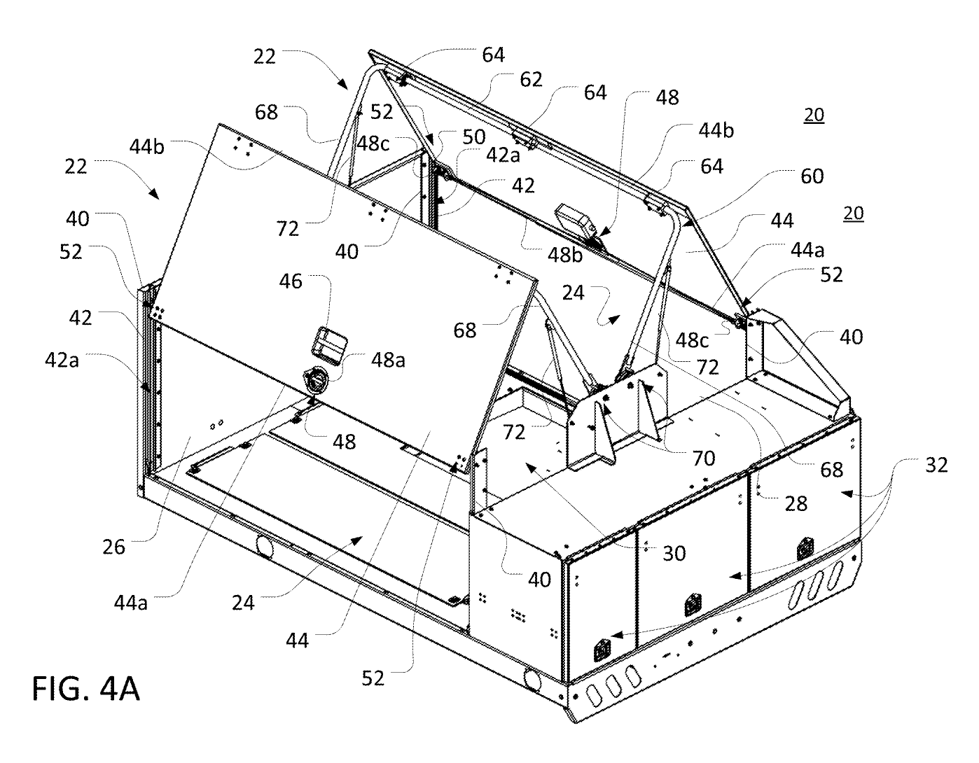

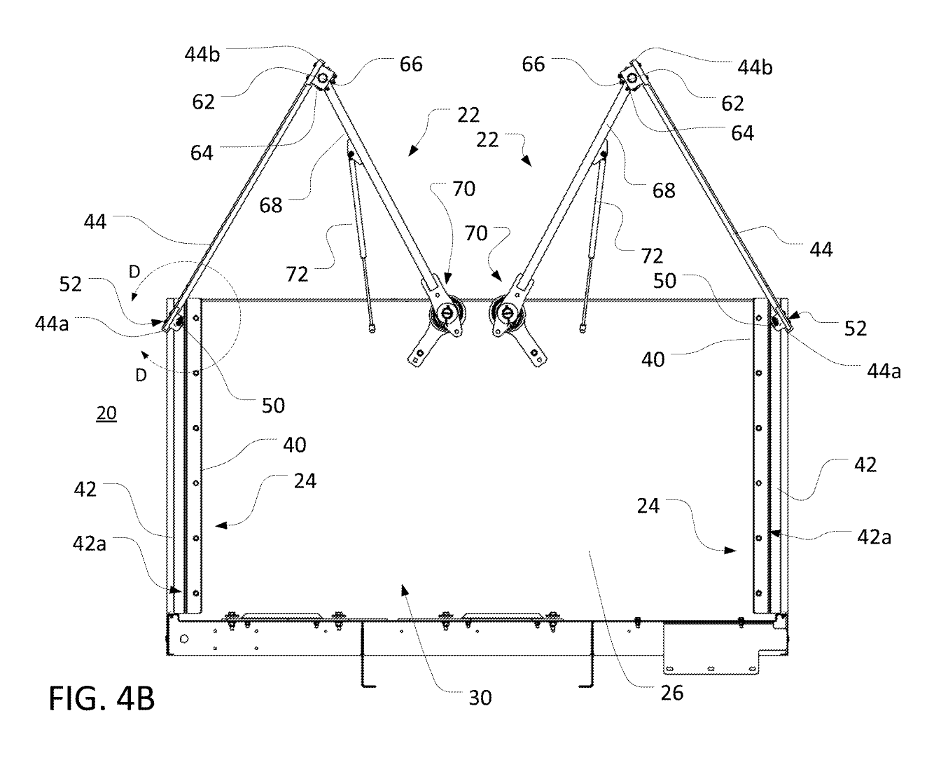

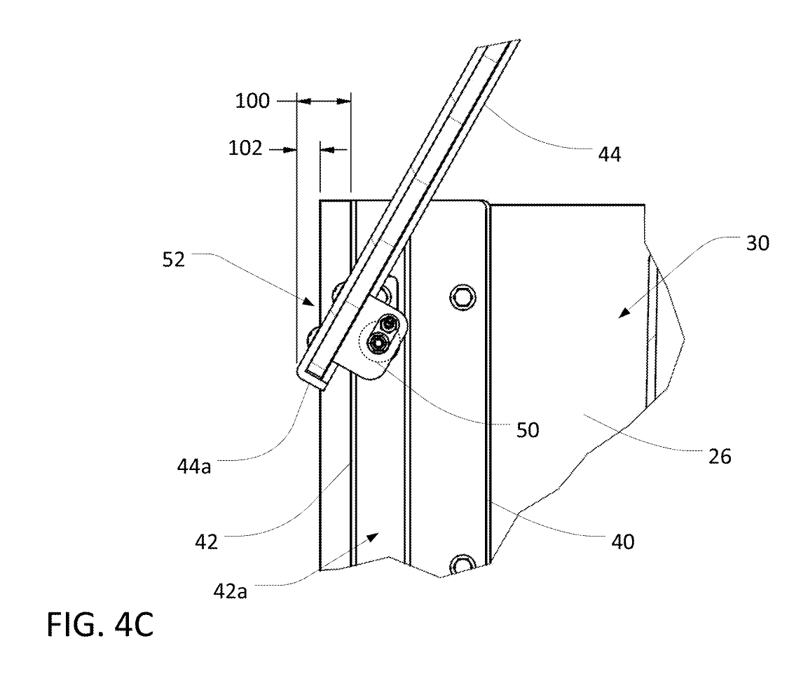

As another example, the gas cylinders 72 can be configured, including as depicted in the figures, to retain pressure when the door panels 44 are closed. The gas cylinders 72 can then use the pressure as the door panels 44 are opened to further assist the upward and inboard movement of the door panels 44. In some embodiments, the gas cylinders 72 can additionally (or alternatively) be configured to resist downward movement of the door panels 44, as the door panels 44 are closed. Indeed, in this regard, the gas cylinders 72 can be configured to hold the door panels 44 in a fully open orientation (see FIGS. 4A and 4B) until overcome by a downward force from a user. In other embodiments, alternative configuration are also possible.

In some embodiments, a user may not need to provide any lifting force to open a door panel. For example, with sufficiently powerful assistive devices (e.g., a spring assembly, or a chargeable damping device such as a gas cylinder), a user may simply need to unlatch the relevant door panel, with the assistive devices providing the entire lifting force. In such an arrangement, the door panel can still be configured to travel in an upward and inboard path similar to the path 100, such that the bottom end of the door panel does not extend substantially beyond the relevant track or frame member.

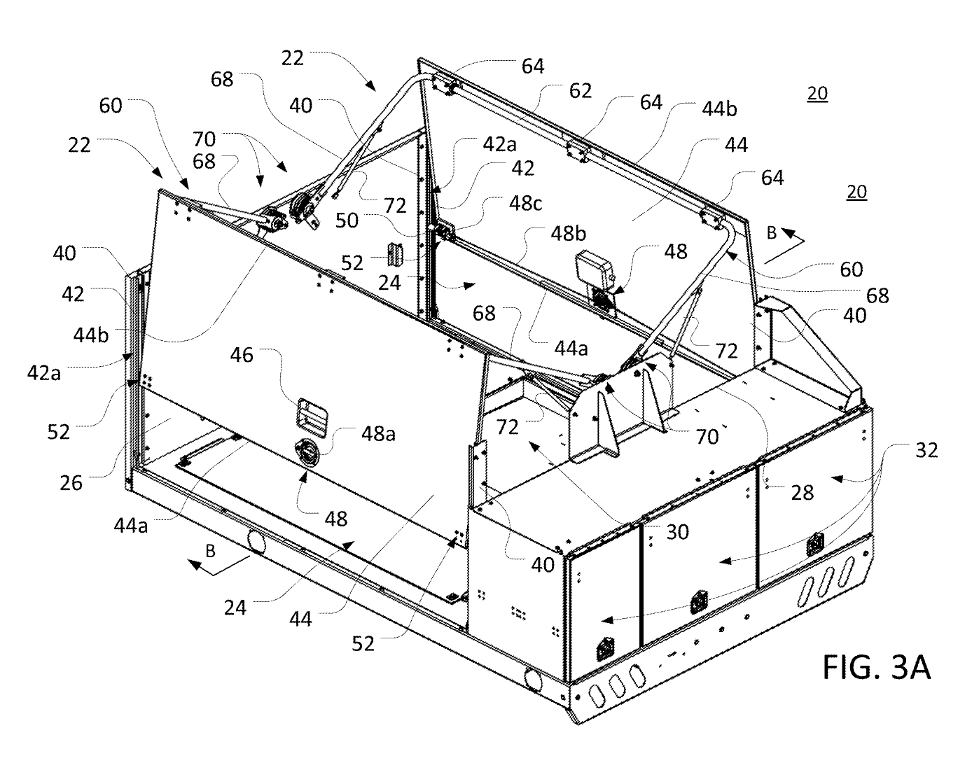

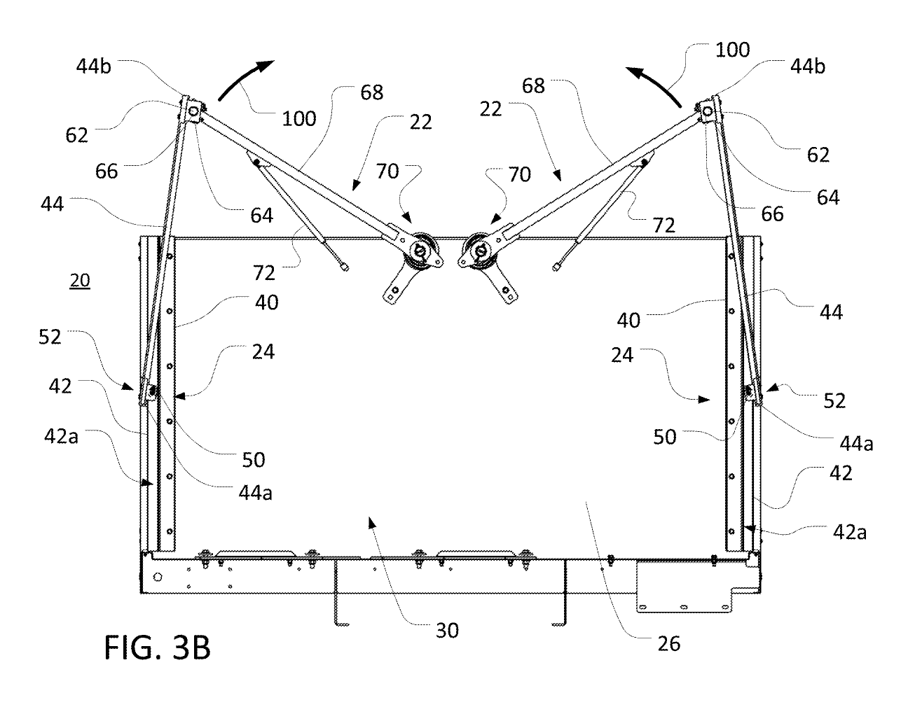

FIGS. 3A and 3B illustrate the door assemblies 22 with each of the door panels 44 having been raised approximately halfway to a fully open orientation. It can be seen that as the pivot arms 68 continue to pivot in an upward and inboard arcuate path (with respect to the orientation depicted in FIGS. 1A and 1B), the rollers 50 continue to move upward in the tracks 42. This causes the door panels 44 to continue upward and inboard along the door paths 100 (see FIG. 3B). Due to the configuration of the door assemblies 22, the bottom ends 44a of the door panels 44 may still not extend substantially outboard of the track 42 or the door frame member 40 (and the compartment 30, generally).

FIGS. 4A and 4B, as noted above, depict the door panels 44 in fully open orientations, with the upper ends of the tracks 42 (or other stops) preventing further upward movement of the door panels 44. Even in this configuration, in which the door panels 44 may have pivoted to a maximum tilt with respect to vertical, the bottom ends 44a of the door panels 44 may still not extend substantially outboard of the track 42 or the door frame member 40 (and the compartment 30, generally). As illustrated in FIG. 4C, for example, a maximum horizontal clearance 100 between an outboard edge of the track 42 and the bottom end 44a of the door panel 44 may be only a small percentage (e.g., 5% or less) of the total height of the door panel 44 (as measured between the top 44b and bottom 44a of the door panel 44). Likewise, a maximum horizontal clearance 102 between the bottom end 44a of the door panel 44 and an outboard edge of the frame member 40 (and the bulkhead wall 26 and the compartment 30, generally) may also be only a small percentage (e.g., 3% or less) of the total height of the door panel 44.

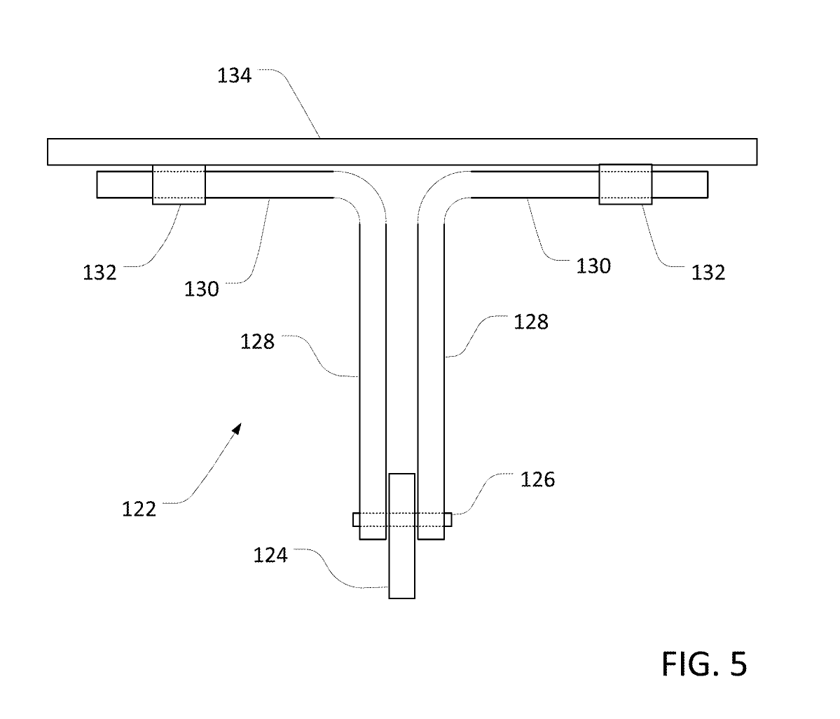

In some embodiments, pivot arms can be arranged somewhat differently from the pivot arms 68 and support members can be arranged somewhat differently from the support member 62. FIG. 5, for example, illustrates a door assembly 122 including a rigid inboard support 124, to which one or more pivot arms 128 can be pivotally mounted (e.g., with a common pivot pin 126). At respective outboard ends, the pivot arms 128 bend away from each other to form horizontal support arms 130. The support arms 130 can then be rotatably secured to a rigid door panel 134 (e.g., via mounting blocks 132), such that the door panel 134 can be opened similarly to the door panel 44 (e.g., as described above). In some embodiments, the pivot arms 128 can be integrally formed with each, or rigidly connected together, or only a single pivot arm 128 may be used. In some embodiments, a biasing or damping assembly can be provided, such as a spring assembly similar to that of the pivot arrangements 70, or a gas cylinder arranged similarly to the cylinders 72.

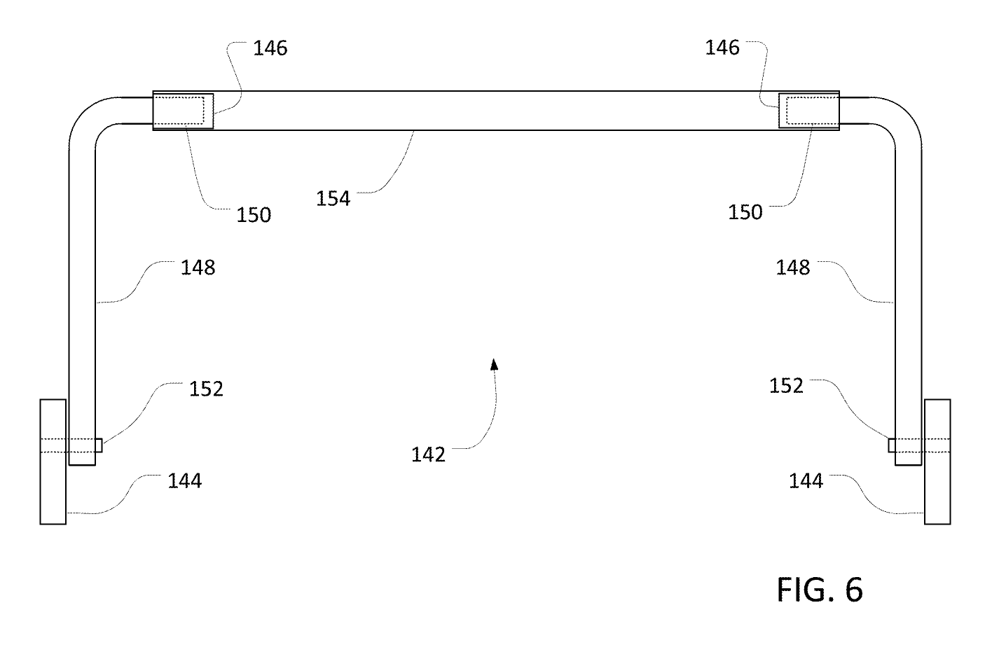

As another example, FIG. 6 illustrates a door assembly 142 including rigid inboard supports 144, to which respective pivot arms 148 can be pivotally mounted (e.g., with respective pivot pins 152). At an outboard end, the pivot arms 148 bend towards each other to form horizontal support arms 150. The support arms 150 can then be rotatably secured to a rigid door panel 154 (e.g., inserted into bores 146 in the door panel 154), such that the door panel 154 can be opened similarly to the door panel 44 (e.g., as described above). In some embodiments, the support arms 150 can extend to form a single support arm (not shown), with the support arms 150 and the pivot arms 148 thereby forming an integral u-shaped support body (not shown) similar to the support body 60 (see, e.g., FIG. 1A). In some embodiments, a biasing or damping assembly can be provided, such as a spring assembly similar to that of the pivot arrangements 70, or a gas cylinder arranged similarly to the cylinders 72.

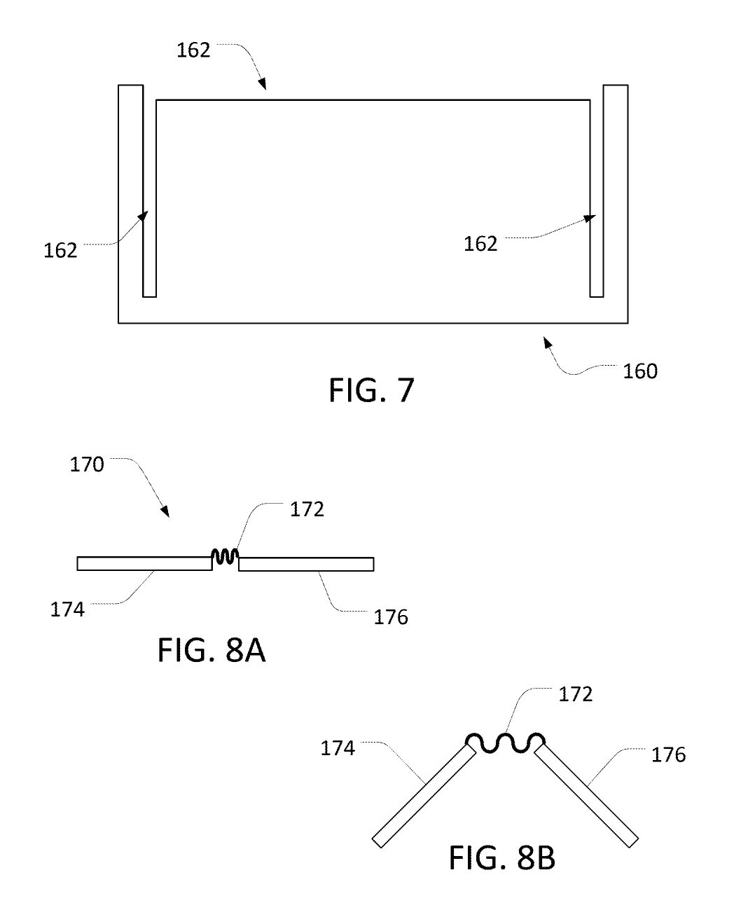

In the various figures, the compartment 30 is depicted without a cover. In some embodiments, a cover (or covers) of various types can be used. In some embodiments, for example, a rigid cover such as cover 160 of FIG. 7 may include slots or cutouts 162 to accommodate the movement of the pivot arms 68, the support members 62, or the door panels 44. In some embodiments, hinged or otherwise foldable covers can be used, such that the covers can pivot or bend in order to accommodate the upward and inboard opening of the door assembly 22. For example, a cover 170 of FIGS. 8A and 8B can include an expandable joint 172 between panels 174 and 176. The panel 174 can be secured to a door panel (not shown in FIGS. 8A and 8B), and the panel 176 can be secured to a frame of the relevant vehicle (not shown) such that the panels 174 and 176 of the cover 170 can pivot and translate relative to one another. In this way, the cover 170 can accommodate the necessary geometrical changes during opening and closing movements of the door panel. In some embodiments, flexible covers such as tarps (not shown) can be used.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. An opening and closing assembly for a vehicle with a compartment, a first inboard frame member, and a door assembly, the door assembly including a rigid door panel configured to at least partly cover a door opening, a roller rotatably attached to the rigid door panel, and a door frame member supporting a track, the track being configured to receive the roller and extending from a bottom end of the track at least partly upward, with respect to the vehicle, the opening and closing assembly comprising:
a support member rotatably attached to the rigid door panel and extending horizontally along the rigid door panel; and
a first pivot arm that is at least one of rigidly connected to and integrally formed with the support member, the first pivot arm extending inboard from the support member, with respect to the utility vehicle, to pivotally attach to the first inboard frame member;
wherein, upon an application of an upward force to the rigid door panel, with the rigid door panel in a closed orientation, the first pivot arm pivots with respect to the first inner frame member to move the support member in an arcuate path extending upward and inboard, with respect to the vehicle, the support member thereby moving the rigid door panel upward and inboard, towards a fully open orientation, along a door path at least partly defined by the track; and
wherein, a lower end of the rigid door panel does not extend substantially outboard of the compartment as the rigid door panel moves between the closed and fully open orientations.

2. The opening and closing assembly of claim 1, further comprising:
a damping device pivotally attached to the first pivot arm, the damping device resisting downward movement of the first pivot arm in order to resist downward movement of the rigid door panel along the door path.

3. The opening and closing assembly of claim 2, wherein the damping device includes a gas cylinder.

4. The opening and closing assembly of claim 1, further comprising:
a spring assembly secured to the first pivot arm and to the first inner frame member, the spring assembly being configured to bias the first pivot arm at least partly upward.

5. The opening and closing assembly of claim 4, wherein the spring assembly includes a spiral tension spring.

6. The opening and closing assembly of claim 1, further comprising:
a second pivot arm that is at least one of rigidly connected to and integrally formed with the support member, the second pivot arm extending inboard from the support member, with respect to the vehicle, to pivotally attach to the vehicle;
wherein, upon the application of the upward force to the rigid door panel, with the rigid door panel in the closed orientation, the second pivot arm pivots to move the support member in the arcuate path, the support member thereby moving the rigid door panel upward and inboard along the door path towards the fully open orientation.

7. The opening and closing assembly of claim 6, wherein the first and second pivot arms and the support member are integrally formed as a u-shaped support body.

8. A door assembly for a vehicle with a door opening and a first inboard frame member, the door assembly comprising:
a rigid door panel configured to at least partly cover the door opening;
a roller rotatably attached to the rigid door panel;
a door frame member;
a track supported by the door frame member, the track being configured to receive the roller and extending from a bottom end of the track at least partly upward, with respect to the vehicle;
a support member rotatably attached to the rigid door panel; and
a first pivot arm that is at least one of rigidly connected to and integrally formed with the support member, the first pivot arm extending inboard from the support member, with respect to the utility vehicle, in order to pivotally attach to the first inboard frame member;
wherein, upon an application of an upward force to the rigid door panel, with the rigid door panel in a closed orientation, the first pivot arm pivots with respect to the first inner frame member to move the support member in an arcuate path upward and inboard, with respect to the vehicle, the support member thereby moving the rigid door panel upward and inboard, towards a fully open orientation of the rigid door panel, along a door path at least partly defined by the track; and
wherein, a lower end of the rigid door panel does not extend substantially outboard of one or more of the door frame member and the track, as the rigid door panel moves between the closed and fully open orientations.

9. The door assembly of claim 8, further comprising:
a damping device pivotally attached to the first pivot arm, the damping device resisting downward movement of the first pivot arm in order to resist downward movement of the rigid door panel along the door path.

10. The door assembly of claim 9, wherein the damping device includes a gas cylinder.

11. The door assembly of claim 8, further comprising:
a spring assembly secured to the first pivot arm and to the first inner frame member, the spring assembly being configured to bias the first pivot arm at least partly upward.

12. The door assembly of claim 11, wherein the spring assembly includes a spiral tension spring.

13. The door assembly of claim 8, wherein the vehicle further includes a first second frame member, further comprising:
a second pivot arm that is at least one of rigidly connected to and integrally formed with the support member, the second pivot arm extending inboard from the support member, with respect to the vehicle, to pivotally attach to a second inner frame member of the vehicle;
wherein, upon the application of the upward force to the rigid door panel, with the rigid door panel in the closed orientation, the second pivot arm pivots with respect to the second inner frame member to move the support member in the arcuate path, the support member thereby moving the rigid door panel upward and inboard along the door path towards the fully open orientation.

14. The door assembly of claim 13, wherein the first and second pivot arms and the central hinge member are integrally formed as a u-shaped support body.

15. A door assembly for a vehicle with a compartment body, the compartment body including an inboard storage compartment, a door opening, first and second bulkhead walls disposed on respective sides of the door opening, and first and second inboard supports, the door assembly comprising:
a rigid door panel configured to at least partly cover the door opening;
first and second tracks supported by the first and second bulkhead walls, respectively, the first and second tracks each extending upward, with respect to the vehicle, from respective first and second bottom ends of the first and second tracks;
first and second rollers rotatably attached to respective sides of the rigid door panel proximate a bottom end of the rigid door panel, the first and second rollers being configured, respectively, to move along the first and second tracks;
a support member pivotally attached to, and extending horizontally along, the rigid door panel; and
first and second pivot arms extending inboard, with respect to the vehicle, from first and second ends, respectively, of the support member to pivotally attach the first and second inboard supports, respectively;
wherein, upon an application of an upward force to the rigid door panel, with the rigid door panel in a closed orientation, the first and second pivot arms pivot with respect to the first and second inboard supports, respectively, to move the support member in an arcuate path upward and inboard, with respect to the vehicle, the horizontal door support thereby moving the rigid door panel upward and inboard, towards a fully open orientation of the rigid door panel, along a door path at least partly defined by the first and second tracks.

16. The door assembly of claim 15, wherein the first and second pivot members and the support member are integrally formed as a u-shaped support body.

17. The door assembly of claim 15, further comprising:
first and second damping devices pivotally attached to the first and second pivot arms, respectively, the first and second damping devices resisting downward movement of the first and second pivot arms, respectively, in order to resist movement of the rigid door panel along the door path.

18. The door assembly of claim 17, wherein at least one of the first and second damping devices includes a gas cylinder.

19. The door assembly of claim 15, further comprising:
first and second spring assemblies secured to the first and second pivot arms, respectively, the first and second spring assemblies being configured, respectively, to bias the first and second pivot arms at least partly upward.

20. The door assembly of claim 19, wherein the spring assembly includes a spiral tension spring.
